(19) United States
(12) Patent Application Publication
(10) Pub. No.: US 2022/0305713 A1
(43) Pub. Date: Sep. 29, 2022

(54) Thermoformed Articles Made From Bio-Based Polymers and Compositions Therefore

(71) Applicant: Celanese International Corporation, Irving, TX (US)

(72) Inventors: Xiaowei Zhang, Union, KY (US); Kevin Norfleet, Dallas, TX (US); Christopher McGrady, Walton, KY (US); Randy Buchman, Florence, KY (US); Camilo Cano, Union, KY (US)

(21) Appl. No.: 17/701,008

(22) Filed: Mar. 22, 2022

Related U.S. Application Data
(60) Provisional application No. 63/165,436, filed on Mar. 24, 2021.
(60) Provisional application No. 63/247,887, filed on Sep. 24, 2021.

(51) Int. Cl. B29C 48/08; C08J 5/18; C08L 1/10; C08K 3/32; C08K 3/014; B29C 48/00

(52) U.S. Cl. CPC B29C 48/08; C08J 5/18; C08L 1/10; C08K 3/32; C08K 3/014; B29C 48/0011; B29C 48/022; C08L 2203/16; C08L 2201/06; C08K 2003/329; C08L 2203/30; B29K 2001/08

(57) ABSTRACT

Biodegradable thermoformed articles are disclosed. The thermoformed articles are formed from a biodegradable polymer composition. The polymer composition contains a cellulose ester polymer, a plasticizer, and one or more other additives. Thermoformed articles can be made in accordance with the present disclosure having low haze and high clarity.

### RELATED APPLICATIONS

The present application is based upon and claims priority to U.S. Provisional Patent Application Ser. No. 63/165,436, having a filing date of Mar. 24, 2021 and U.S. Provisional Patent Application Ser. No. 63/247,887, having a filing date of Sep. 24, 2021, both of which are incorporated herein by reference.

### BACKGROUND

Each year, the global production of plastics continues to increase. Over one-half of the amount of plastics produced each year are used to produce plastic bottles, containers, container lids, and other single-use items. The discarded, single-use plastic articles, including all different kinds of packaging, are typically not recycled and end up in landfills. In addition, many of these items are not properly disposed of and end up in streams, lakes, and in the oceans around the world. In fact, plastic waste tends to agglomerate and concentrate in oceans in certain areas of the world due to currents and the buoyancy of the products.

In view of the above, those skilled in the art have attempted to produce plastic articles made from biodegradable polymers. Many biodegradable polymers, however, lack the physical properties and characteristics of conventional polymers, such as polypropylene and/or polyethylene.

One type of method for producing plastic articles is thermoforming. During thermoforming, plastic sheets or films are heated and then manipulated into a desired three-dimensional shape. The film can be formed over a male mold or a female mold. There are two main types of thermoforming typically referred to as vacuum forming or pressure forming. Both types of thermoforming use heat and pressure in order to form a film into its final shape. During vacuum forming, a plastic film is placed over a mold and vacuum is used to manipulate it into a three-dimensional article. During pressure forming, pressure optionally in combination with vacuum forces are used to mold the film into a shape.

The use of thermoforming to produce three-dimensional articles has various advantages. For instance, thermoforming allows for the production of all different types of shapes with fast turnaround times. Modifications to designs can also occur quickly and efficiently. Thermoforming can also be cost effective and can produce articles having an aesthetic appearance.

In order to move away from petroleum-based polymers, such as polyolefin polymers, those skilled in the art have attempted to incorporate bio-based polymers or biodegradable polymers into thermoforming processes. For example, polylactide has been proposed as a replacement to petroleum-based polymers for producing various different articles through thermoforming, such as packages for food products. Polylactide, however, has a relatively low melting point and is not well suited to being subjected to higher temperatures. Consequently, polylactide has limits and drawbacks, especially when producing packaging or containers for hot food items.

In view of the above, a need currently exists for a biodegradable polymer composition well suited for forming three-dimensional articles through thermoforming. A need also exists for a polymer composition containing primarily a biodegradable polymer well suited for forming films that can then be used in thermoforming processes.

### SUMMARY

In general, the present disclosure is directed to a biodegradable polymer composition well suited to producing thermoformed articles and products with good mechanical performance in combination with excellent aesthetics. In accordance with the present disclosure, the biodegradable polymer composition contains a cellulose ester polymer that is not only biodegradable but can be formed from renewable resources. Of particular advantage, the polymer composition can be formulated to have extremely good optical properties, such as low haze and high clarity, especially in relation to thermoformed articles made in the past from similar biodegradable polymers. In addition, the polymer composition can be formulated to have a relatively high melting point that produces articles having high temperature resistance. Consequently, articles made according to the present disclosure can be used in high temperature applications, such as to hold hot food items.

In one embodiment, for instance, the present disclosure is directed to a thermoformed article. The thermoformed article is formed from a film comprising a biodegradable polymer. The biodegradable polymer comprises a cellulose ester polymer, such as a cellulose acetate. In one aspect, the cellulose acetate polymer comprises primarily cellulose diacetate. The cellulose ester polymer can also have a degree of acetyl substitution of from about 2.1 to about 2.8. The film further comprises a plasticizer. The plasticizer can be present in the film in an amount from about 12% by weight to about 48% by weight.

In addition to a cellulose ester polymer, the thermoformed article can optionally contain at least one other bio-based polymer. The at least one bio-based polymer, for instance, can comprise a polylactic acid, a polycaprolactone, a polyhydroxyalkanoate, a polybutylene succinate, a polybutylene adipate terephthalate, a starch such as a plasticized starch, or mixtures thereof. The one or more bio-based polymers can be present in the polymer composition in an amount from about 1% by weight to about 50% by weight, such as in an amount of about 3% by weight or greater, such as in an amount of about 5% by weight or greater, such as in an amount of about 7% by weight or greater, such as in an amount of about 10% by weight or greater, and generally in an amount less than about 30% by weight.

The thermoformed article can also contain an antioxidant. The antioxidant can comprise a phosphite, such as a diphosphite. The antioxidant can be present in the film in an amount from about 0.001% by weight to about 0.35% by weight.

In accordance with the present disclosure, in order to form a three-dimensional article, the film is subjected to heat and pressure sufficient to form a defined shape. The three-dimensional article, for instance, can include at least one wall wherein each wall has sufficient rigidity in order to provide shape retention.

The polymer film used to form the three-dimensional article can be an extruded film. The film can be uniaxially stretched or biaxially stretched. In another aspect, the three-dimensional article can be formed without first stretching the film.

In addition to an antioxidant, in one embodiment, the three-dimensional polymer article may also contain a polycarboxylic acid. A polycarboxylic acid is an acid containing two or more carboxylic groups. In one aspect, the polycarboxylic acid can be citric acid. The polycarboxylic acid can be present in the three-dimensional article generally in an amount from about 0.001% by weight to about 0.1% by weight.

The plasticizer present in the three-dimensional article can be a triglyceride. One suitable plasticizer, for instance, is 1,2,3-triacetalglycol. Other suitable plasticizers include monoacetin, diacetin, tris(chloroisopropyl)phosphate, tris(2-chloro-1-methylethyl)phosphate, glycerin, triethyl citrate, acetyl triethyl citrate, an adipate, polyethylene glycol, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, an aromatic diol, a substituted aromatic diol, an aromatic ether, tripropionin, tribenzoin, a glycerin ester, glycerol tribenzoate, glycerol acetate benzoate, polyethylene glycol, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrrolidinone, propylene carbonate, a C1-C20 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, a piperidine, a piperazine, hexamethylene diamine, triazine, triazole, a pyrrole, and mixtures thereof.

In one aspect, the three-dimensional article contains the cellulose ester polymer in an amount from about 62% by weight to about 74% by weight and contains one or more plasticizers in an amount from about 27% by weight to about 36% by weight.

Three-dimensional articles made according to the present disclosure can be formed with excellent optical properties. For instance, the three-dimensional articles can be transparent or translucent such that a user can view the contents of the three-dimensional article through the walls of the article. At least one wall of the three-dimensional article, for instance, can have a haze when measured according to ASTM Test D1003 (2013) of less than about 10%, such as less than about 5%, such as less than about 2%, such as less than about 1%, such as less than about 0.5%, such as less than about 0.3%. At least one wall of the three-dimensional article can also have a light transmission at a wavelength of anywhere from 380 nm to about 780 nm of greater than about 70%, such as greater than about 80%, such as greater than about 85%, such as greater than about 90%, such as greater than about 95%.

When tested according to the gel analysis test, thermoformed films and articles made according to the present disclosure can show dramatically low defect levels. For example, films and articles made according to the present disclosure can contain less than about 5,000 defects/m², such as less than about 3,500 defects/m², such as less than about 2,000 defects/m² of defects having a size of 300 microns or greater. Films and articles made according to the present disclosure can exhibit defects in the size of 200 microns or greater in an amount of less than about 25,000 defects/m2, such as less than about 20,000 defects/m², such as less than about 15,000 defects/m². The film and articles can also exhibit defects having a size of 100 microns or greater at a level of less than about 70,000 defects/m², such as less than about 60,000 defects/m², such as less than about 50,000 defects/m².

Films and articles made according to the present disclosure can display a total defect area of less than about 9,000 mm², such as less than about 8,000 mm², such as less than about 7,000 mm², such as less than about 6,000 mm², such as less than about 5,000 mm², such as less than about 4,000 mm², such as less than about 3,000 mm², such as less than about 2,000 mm².

All different types of articles and products can be made in accordance with the present disclosure. In one aspect, the three-dimensional article comprises food packaging or all other types of packaging. The packaging can be rigid, semi-rigid or flexible. The packaging can be used to hold all different types of food products, such as meat products, eggs, fresh fruit, produce, and the like. The packaging can also be used to hold and store various different medical components, such as tools, syringes, needles, tubing, and vials.

Thermoformed products made according to the present disclosure can be used in all different types of industries to produce a limitless variety of products. For example, various medical equipment can be made in accordance with the present disclosure including medical electronics housing, imaging enclosures, sterile packaging, bins, trays, hospital room panels, hospital bed components, stands and support equipment, and the like. Articles made according to the present disclosure can also be used to produce all different types of parts in the automotive industry. Such parts include dashboard assemblies, interior door panels, interior paneling, seat parts, engine bay paneling, exterior body panels, bumpers, air ducts, trunk liners, glove compartments, guards, spoilers, window louvres, and the like.

Articles made according to the present disclosure can also be used in the aviation field to produce aircraft interior paneling, galley components, overhead luggage bins, seat parts, window shades, light housings, ductwork parts, arm rests, foldable tray tables, and the like. Articles made according to the present disclosure can also be used to produce parts for business machines and equipment. For instance, products made according to the present disclosure include printer enclosures, fax machine enclosures, electronic enclosures, panels, bezels, office furniture parts, computer enclosures, and electronic packaging.

Articles made according to the present disclosure can also be used in the building and construction industry to produce all different types of products such as equipment enclosures, skylight parts, tool cases, machinery covers, and the like. Thermoformed products made according to the present disclosure can also be used to produce all different types of consumer appliance parts. For instance, the thermoforming process of the present disclosure can be used to produce refrigerator parts, refrigerator and freezer door liners, dishwasher parts, parts for clothes dryers, parts for window air conditioners, and parts for other various different consumer appliances, including television cabinets.

Articles made according to the present disclosure can also be used to produce all different types of recreation products. Recreation products that can be made according to the present disclosure include parts for exercise and fitness machines, equipment enclosures, external panels for recreational vehicles, protective cases in order to store all different types of athletic equipment, fishing boat hulls, canoe and boat parts, windshields for boats, snowmobiles and motorcycles, and the like. Thermoformed articles made according to the present disclosure are also well suited for use in the horticulture industry. Products that can be made include, for instance, plant trays, flowerpots, and the like.

The polymer composition of the present disclosure can also be used to thermoform various different containers. Such containers include bins, trays, bases. In addition, all different types of drinking containers or other food containers and beverage holders can be made according to the present disclosure. Such beverage containers can include cups or tops to cups.

The present disclosure is also directed to a polymer composition for producing the three-dimensional articles. The polymer composition can contain a cellulose ester polymer in an amount from about 62% by weight to about 74% by weight. The cellulose ester polymer can comprise cellulose acetate, such as cellulose diacetate. The polymer composition further contains at least one plasticizer. The plasticizer can comprise a triglyceride and can be present in the polymer composition in an amount from about 27% by weight to about 36% by weight. The polymer composition can further contain an antioxidant, such as a diphosphite in an amount from about 0.001% by weight to about 0.35% by weight. The polymer composition can also contain a polycarboxylic acid, such as citric acid. The polycarboxylic acid can be present in the polymer composition in an amount from about 0.001% by weight to about 0.1% by weight.

The polymer composition described above can be extruded into a film and, at a thickness of 1 mm, can display a haze of less than about 5%, such as less than about 2%, such as less than about 1%, such as less than about 0.5%, such as less than about 0.4%, such as less than about 0.3%, such as less than about 0.2% when tested according to ASTM Test D1003. The film can then be used in thermoforming processes for producing all different types of three-dimensional products.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying FIGURE, in which:

FIG. 1 is a perspective view of one embodiment of a food container that may be made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a plasticized cellulose ester polymer composition well suited to producing thermoformed articles. For example, the polymer composition can first be formed into an extruded film. The film can have any suitable thickness. The film can then be subjected to a thermoforming process and subjected to sufficient heat and pressure while in contact with a mold in order to produce a three-dimensional article having a defined shape.

In one aspect, the polymer composition can be formulated so as to not only have good mechanical properties but also can possess excellent optical properties. Thermoformed articles made according to the present disclosure, for instance, can be made highly transparent or translucent. For example, when used for packaging, the contents of the three-dimensional article can be viewed through the walls. The three-dimensional articles made according to the present disclosure can also have very low haze while having high clarity.

In one aspect, for instance, thermoformed films and/or articles made according to the present disclosure can be subjected to a gel analysis test that can relate to the high clarity characteristics of products made according to the present disclosure. The gel analysis test can be conducted by an FSA-100 film surface analyzer commercially available from OCS GmbH of Witten, Germany. The film surface analyzer can include a 4096 pixel CMOS digital camera with a complementary metal oxide semiconductor sensor. The film surface analyzer can have a 50 micron nominal resolution and can include an LED lighting system that enables optimal defect detection in transparent, opaque and colored polymer films. Films can be tested according to the present disclosure at any suitable thickness, such as at a thickness of 25.4 microns. The FSA LID setting is set at 40. The parcel length is set at 102.4 mm and the parcel width is set at 80.00 mm. The parcel area is 8192.00 mm². 367 parcels are inspected and the inspection area is 3.006 m². The inspected length is 37.581 m. The levels are set at 40%-10%. The other settings include gray value at 169, mean filter size at 50 (50), film speed at 7.01 m/min, exposure time at 0.013 ms, transparency/noise set at 98.88%/2.83%, X resolution set at 50 microns, and Y resolution set at 50 microns. The gel analysis test measures the number of defects per area and the size of the defects.

Films and articles made according to the present disclosure, for instance, can display defects having a size of 300 microns or greater of less than about 5,000 defects/m², such as less than about 3,500 defects/m², such as less than about 2,000 defects/m². Films and articles made according to the present disclosure can display defects having a size of 200 microns or greater in an amount less than about 25,000 defects/m², such as in an amount less than about 20,000 defects/m², such as in an amount of less than about 15,000 defects/m². Films and articles made according to the present disclosure can display defects having a size of 100 microns or greater in an amount less than about 70,000 defects/m², such as in an amount less than about 60,000 defects/m², such as in an amount of less than about 50,000 defects/m².

Films and articles made according to the present disclosure can have a total defect area of less than about 9,000 mm², such as less than about 8,000 mm², such as less than about 7,000 mm², such as less than about 6,000 mm², such as less than about 5,000 mm², such as less than about 4,000 mm², such as less than about 3,000 mm², such as less than about 2,000 mm².

The above gel analysis characteristics can lead to films and articles displaying excellent haze and transparency.

For example, polymer articles made according to the present disclosure can be measured for haze according to ASTM Test D1003 (2013). Haze can be measured using any acceptable instrument according to the ASTM Test including, for instance, a BYK Gardner Haze-Gard 4725 instrument. Haze can be measured on a test plaque, on a film made according to the present disclosure, or on the final thermoformed article. The test plaque can have any suitable thickness, such as 1 mm, 2 mm, 3 mm, or 4 mm. When any of the above samples are tested, the haze of the sample or article can generally be less than about 10%, such as less than about 8%, such as less than about 5%, such as less than about 3%, such as less than about 2%. In one aspect, the haze can be less than 1%, such as less than about 0.8%, such as less than about 0.5%, such as less than about 0.4%, such as less than about 0.3%, such as less than about 0.2%.

In the past, haze properties typically degraded after an article was thermoformed into shape. The polymer composition of the present disclosure, however, has been particularly formulated so that the material is easy to process during thermoforming operations and can produce thermoformed articles without any significant degradation in haze or other optical properties.

In addition to low haze, polymer films and articles made according to the present disclosure can also have high transmission rates, whether the article is translucent (e.g. is a shade of color containing one or more coloring agents) or transparent. For example, when measured for transmission properties at a wavelength of from about 380 nm to about 780 nm, the polymer film or article can display a transmission of greater than about 70%, such as greater than about 75%, such as greater than about 80%, such as greater than about 85%, such as greater than about 90%, such as greater than about 95%.

In accordance with the present disclosure, the polymer composition contains a cellulose ester polymer combined with at least one plasticizer and optionally one or more other bio-based polymers. In addition, the polymer composition contains at least one antioxidant and/or a polycarboxylic acid and optionally various other additives and ingredients. The polymer composition is particularly formulated to produce films having excellent optical properties. The films can then be used in thermoforming processes for producing three-dimensional articles. Of particular advantage, the optical properties of the films are retained in the three-dimensional articles even after being manipulated during the thermoforming process.

In general, any suitable cellulose ester polymer can be incorporated into the polymer composition of the present disclosure. In one aspect, the cellulose ester polymer is a cellulose acetate.

Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the composition of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

The cellulose acetate used in the composition may be cellulose diacetate or cellulose triacetate. In one embodiment, the cellulose acetate comprises primarily cellulose diacetate. For example, the cellulose acetate can contain less than 1% by weight cellulose triacetate, such as less than about 0.5% by weight cellulose triacetate. Cellulose diacetate can make up greater than 90% by weight of the cellulose acetate, such as greater than about 95% by weight, such as greater than about 98% by weight, such as greater than about 99% by weight of the cellulose acetate.

In general, the cellulose acetate can have a molecular weight of greater than about 10,000, such as greater than about 20,000, such as greater than about 30,000, such as greater than about 40,000, such as greater than about 50,000. The molecular weight of the cellulose acetate is generally less than about 300,000, such as less than about 250,000, such as less than about 200,000, such as less than about 150,000, such as less than about 100,000, such as less than about 90,000, such as less than about 70,000, such as less than about 50,000. The molecular weights identified above refer to the number average molecular weight. Molecular weight can be determined using gel permeation chromatography using a polystyrene equivalent or standard.

The biodegradation of the cellulose ester polymer can depend upon various factors including the degree of substitution. The degree of substitution of cellulose ester can be measured, for example, using ASTM Test 871-96 (2010). The cellulose acetate polymer incorporated into the polymer composition can generally have a degree of substitution of greater than about 2.0, such as greater than about 2.1, such as greater than about 2.2, such as greater than about 2.3. The degree of substitution is generally less than about 3.0, such as less than about 2.8, such as less than about 2.6, such as less than about 2.4. In one aspect, for instance, the cellulose acetate polymer has a degree of substitution of from about 2.1 to about 2.8, including all increments of 0.1 therebetween.

The cellulose ester polymer or cellulose acetate can have an intrinsic viscosity of generally greater than about 0.5 dL/g, such as greater than about 0.8 dL/g, such as greater than about 1 dL/g, such as greater than about 1.2 dL/g, such as greater than about 1.4 dL/g, such as greater than about 1.6 dL/g. The intrinsic viscosity is generally less than about 2 dL/g, such as less than about 1.8 dL/g, such as less than about 1.7 dL/g, such as less than about 1.65 dL/g. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( antilog ( ( log {n}_{ret} ) / k ) - 1 ) where {n}_{ret} = ( \frac{{t}_{1}}{{t}_{2}} ) , \qquad Equation 1$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

The cellulose acetate is generally present in the polymer composition in an amount greater than about 20% by weight, such as in an amount greater than about 25% by weight, such as in an amount greater than about 30% by weight, such as in an amount greater than about 35% by weight, such as in an amount greater than about 40% by weight, such as in an amount greater than about 45% by weight, such as in an amount greater than about 50% by weight, such as in an amount greater than about 55% by weight, such as in an amount greater than about 62% by weight, such as in an amount greater than about 65% by weight. The cellulose acetate is generally present in the polymer composition in an amount less than about 85% by weight, such as in an amount less than about 82% by weight, such as in an amount less than about 80% by weight, such as in an amount less than about 74% by weight, such as in an amount less than about 71% by weight. When one or more other bio-based polymers are present in the polymer composition, the cellulose acetate can be present in the composition in an amount less than about 65% by weight, such as in an amount less than about 55% by weight, such as in an amount less than about 45% by weight, such as in an amount less than about 35% by weight.

In accordance with the present disclosure, the cellulose ester polymer is combined with one or more plasticizers.

Plasticizers particularly well suited for use in the polymer composition include polyglycerides. For example, the plasticizer can comprise a monoglyceride, a diglyceride, or a triglyceride. In one particular aspect, the plasticizer comprises 1,2,3-triacetylglycol. In other aspects, however, the plasticizer can be a diacetylglycol or a monoacetylglycol alone or in combination with a triacetylglycol. Other suitable plasticizers include tris(chloroisopropyl) phosphate, tris(2-chloro-1-methylethyl) phosphate, triethyl citrate, acetyl triethyl citrate, glycerin, or mixtures thereof.

Other examples of plasticizers include, but are not limited to, trimethyl phosphate, triethyl phosphate, tributyl phosphate, triphenyl phosphate, acetyl tributyl citrate, tributyl-o-acetyl citrate, dibutyl tartrate, ethyl o-benzoylbenzoate, n-ethyltoluenesulfonamide, o-cresyl p-toluenesulfonate, aromatic diol, substituted aromatic diols, aromatic ethers, tripropionin, tribenzoin, glycerin, glycerin esters, glycerol tribenzoate, glycerol acetate benzoate, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrrolidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., .gamma.-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

In one aspect, a carbonate ester may serve as a plasticizer. Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

In still another aspect, the plasticizer can be a polyol benzoate. Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, sucrose benzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

In one aspect, the plasticizer can be a sulfonamide plasticizer. For instance, the plasticizer can be a toluene sulfonamide plasticizer. The toluene sulfonamide plasticizer can have a melting point of less than about 120° C., such as less than about 115° C. The sulfonamide plasticizer can be combined with any of the other plasticizers described above.

In one aspect, the plasticizer is phthalate-free. In fact, the polymer composition can be formulated to be phthalate-free. For instance, phthalates can be present in the polymer composition in an amount of about 0.1% or less, such as in an amount of about 0.001% or less.

In general, one or more plasticizers can be present in the polymer composition in an amount from about 5% to about 48% by weight, such as from about 18% to about 48% by weight, such as in an amount from about 27% to about 36% by weight. In one aspect, one or more plasticizers can be present in the polymer composition in an amount of greater than about 20% by weight, such as in an amount greater than about 23% by weight, such as in an amount greater than about 25% by weight, such as in an amount greater than about 27% by weight, such as in an amount greater than about 29% by weight, and generally in an amount less than about 43% by weight, such as in an amount less than about 36% by weight.

In one aspect, the polymer composition of the present disclosure can optionally contain at least one bio-based polymer in addition to the cellulose acetate polymer. As used herein, a “bio-based polymer” refers to a polymer produced at least partially from renewable biomass sources, such as produced from plant matter or food waste. For example, a bio-based polymer can be a polymer produced from greater than about 30% renewable sources, such as greater than about 50% renewable sources, such as greater than about 70% renewable sources, such as greater than about 90% renewable sources and are to be distinguished from polymers derived from fossil resources, such as petroleum.

In one aspect, the at least one bio-based polymer combined with the cellulose acetate is a polyhydroxyalkanoate. The polyhydroxyalkanoate can be a homopolymer or a copolymer. Polyhydroxyalkanoates, also known as “PHAs”, are linear polyesters produced in nature by bacterial fermentation of sugar or lipids. More than 100 different monomers can be combined within this family to give materials with extremely different properties. Generally, they can be either thermoplastic or elastomeric materials, with melting-points ranging from 40 to 180° C. The most common type of PHAs is PHB (poly-beta-hydroxybutyrate). Poly(3-hydroxybutyrate) (PHB) is a type of a naturally occurring thermoplastic polymer currently produced microbially inside of the cell wall of a number of wild bacteria species or genetically modified bacteria or yeasts, etc. It is biodegradable and does not present environmental issues post disposal, i.e., articles made from PHB can be composted.

The one or monomers used to produce a PHA can significantly impact the physical properties of the polymer. For example, PHAs can be produced that are crystalline, semi-crystalline, or completely amorphous. For example, poly-4-hydroxybutyrate homopolymer can be completely amorphous with a glass transition temperature of less than about −30° C. and with no noticeable melting point temperature. Polyhydroxybutyrate-valerate copolymers also can be formulated to be semi-crystalline to amorphous having low stiffness characteristics.

Examples of monomer units that can be incorporated in PHAs include 2-hydroxybutyrate, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HH), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

In some embodiments, the PHA in the methods described herein is a homopolymer (where all monomer units are the same). Examples of PHA homopolymers include poly 3-hydroxyalkanoates (e.g., poly 3-hydroxypropionate (hereinafter referred to as P3HP)), poly 3-hydroxybutyrate (hereinafter referred to as P3HB) and poly 3-hydroxyvalerate, poly 4-hydroxyalkanoates (e.g., poly 4-hydroxybutyrate (hereinafter referred to as P4HB)), poly 4-hydroxyvalerate (hereinafter referred to as P4HV)) or poly 5-hydroxyalkanoates (e.g., poly 5-hydroxyvalerate (hereinafter referred to as P5HV)).

In certain embodiments, the PHA can be a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as P3HB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV).

An example of a PHA having 4 different monomer units would be PHB-co-3HH-co-3HO-co-3HD or PHB-co-3-HO-co-3HD-co-3HDd. Typically where the PHB3HX has 3 or more monomer units, the 3HB monomer is at least 70% by weight of the total monomers, such as greater than 90% by weight of the total monomers.

In one embodiment of the present disclosure, a cellulose acetate is combined with a PHA that has a crystallinity of about 25% or less and has a low glass transition temperature. For instance, the glass transition temperature can be less than about 10° C., such as less than about 5° C., such as less than about 0° C., such as less than about −5° C., and generally greater than about −40° C., such as greater than about −20° C. Such PHAs can dramatically reduce the stiffness properties of the cellulose acetate, thereby increasing the elongation properties and decreasing the flexural modulus properties. As used herein, the glass transition temperature can be determined by dynamic mechanical analysis in accordance with ASTM Test E1640-09.

When present, one or more PHAs can be contained in the polymer composition in an amount of about 2% or greater, such as about 3% or greater, such as about 5% or greater, such as about 7% or greater, such as about 10% or greater, such as about 12% or greater, such as about 15% or greater, such as about 18% or greater. One or more PHAs are generally present in the polymer composition in an amount of about 30% or less, such as in an amount of about 25% or less, such as in an amount of about 20% or less, such as in an amount of about 15% or less.

In addition to one or more PHAs, the polymer composition can contain various other bio-based polymers, such as a polylactic acid or a polycaprolactone. Polylactic acid also known as “PLAs” are well suited for combining with one or more PHAs. Polylactic acid polymers are generally stiffer and more rigid than PHAs and thus can be added to the polymer composition for further refining the properties of the overall formulation.

Polylactic acid may generally be derived from monomer units of any isomer of lactic acid, such as levorotary-lactic acid (“L-lactic acid”), dextrorotatory-lactic acid (“D-lactic acid”), meso-lactic acid, or mixtures thereof. Monomer units may also be formed from anhydrides of any isomer of lactic acid, including L-lactide, D-lactide, meso-lactide, or mixtures thereof. Cyclic dimers of such lactic acids and/or lactides may also be employed. Any known polymerization method, such as polycondensation or ring-opening polymerization, may be used to polymerize lactic acid. A small amount of a chain-extending agent (e.g., a diisocyanate compound, an epoxy compound or an acid anhydride) may also be employed. The polylactic acid may be a homopolymer or a copolymer, such as one that contains monomer units derived from L-lactic acid and monomer units derived from D-lactic acid. Although not required, the content of one of the monomer units derived from L-lactic acid and the monomer units derived from D-lactic acid is preferably about 85 mole % or more, in some embodiments about 90 mole % or more, and in some embodiments, about 95 mole % or more. Multiple polylactic acids, each having a different ratio between the monomer unit derived from L-lactic acid and the monomer unit derived from D-lactic acid, may be blended at an arbitrary percentage.

In one particular embodiment, the polylactic acid has the following general structure:

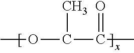

The polylactic acid typically has a number average molecular weight (“Mₙ”) ranging from about 40,000 to about 160,000 grams per mole, in some embodiments from about 50,000 to about 140,000 grams per mole, and in some embodiments, from about 80,000 to about 120,000 grams per mole. Likewise, the polymer also typically has a weight average molecular weight (“M_{w}”) ranging from about 80,000 to about 200,000 grams per mole, in some embodiments from about 100,000 to about 180,000 grams per mole, and in some embodiments, from about 110,000 to about 160,000 grams per mole. The ratio of the weight average molecular weight to the number average molecular weight (“M_{w}/Mₙ”), i.e., the “polydispersity index”, is also relatively low. For example, the polydispersity index typically ranges from about 1.0 to about 3.0, in some embodiments from about 1.1 to about 2.0, and in some embodiments, from about 1.2 to about 1.8. The weight and number average molecular weights may be determined by methods known to those skilled in the art.

The polylactic acid may also have an apparent viscosity of from about 50 to about 600 Pascal seconds (Pas), in some embodiments from about 100 to about 500 Pas, and in some embodiments, from about 200 to about 400 Pas, as determined at a temperature of 190° C. and a shear rate of 1000 sec⁻¹. The melt flow rate of the polylactic acid (on a dry basis) may also range from about 0.1 to about 40 grams per 10 minutes, in some embodiments from about 0.5 to about 20 grams per 10 minutes, and in some embodiments, from about 5 to about 15 grams per 10 minutes, determined at a load of 2160 grams and at 190° C.

Polylactic acid can be present in the polymer composition in an amount of about 1% or greater, such as in an amount of about 3% or greater, such as in an amount of about 5% or greater, and generally in an amount of about 20% or less, such as in an amount of about 15% or less, such as in an amount of about 10% or less, such as in an amount of about 8% or less.

As described above, another bio-based polymer that may be combined with cellulose acetate alone or in conjunction with other bio-based polymers is polycaprolactone. Polycaprolactone, similar to PHAs, can be formulated to have a relatively low glass transition temperature. The glass transition temperature, for instance, can be less than about 10° C., such as less than about −5° C., such as less than about −20° C., and generally greater than about −60° C. The polymers can be produced so as to be amorphous or semi-crystalline. The crystallinity of the polymers can be less than about 50%, such as less than about 25%.

Polycaprolactones can be made having a number average molecular weight of generally greater than about 5,000, such as greater than about 8,000, and generally less than about 15,000, such as less than about 12,000. Low molecular weight polycaprolactones can also be produced and used as plasticizers.

Polycaprolactones can be contained in the polymer composition in an amount of about 2% or greater, such as about 3% or greater, such as about 5% or greater, such as about 7% or greater, such as about 10% or greater, such as about 12% or greater, such as about 15% or greater, such as about 18% or greater. Polycaprolactones are generally present in the polymer composition in an amount of about 30% or less, such as in an amount of about 25% or less, such as in an amount of about 20% or less, such as in an amount of about 15% or less.

Other bio-based polymers that may be incorporated into the polymer composition include polybutylene succinate, polybutylene adipate terephthalate, a plasticized starch, other starch-based polymers, and the like. In addition, the bio-based polymer can be a polyolefin or polyester polymer made from renewable resources. For example, such polymers include bio-based polyethylene, bio-based polybutylene terephthalate, and the like.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In one aspect, the antioxidant incorporated into the polymer composition is a phosphite. For example, the antioxidant can be a polyphosphite, such as a diphosphite. In one particular embodiment, for instance, the antioxidant incorporated into the polymer composition is Bis(2,4-dicumylphenyl) pentaerythritol diphosphite.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, phosphites, and the like, and any combination thereof.

Any of the above antioxidants, including the phosphites described above, can be incorporated into the polymer composition generally in an amount greater than about 0.001% by weight, such as in an amount greater than about 0.01% by weight, such as in an amount greater than about 0.05% by weight, such as in an amount greater than about 0.08% by weight, and generally in an amount less than about 0.35% by weight, such as in an amount less than about 0.3% by weight, such as in an amount less than about 0.25% by weight, such as in an amount less than about 0.2% by weight, such as in an amount less than about 0.15% by weight, such as in an amount less than about 0.1% by weight. In one embodiment, the polymer composition contains a phosphite antioxidant alone or in combination with one of the other antioxidants described above.

The polymer composition of the present disclosure can also include a polycarboxylic acid. The polycarboxylic acid, for instance, can be a dicarboxylic acid or a tricarboxylic acid. In one aspect, the polycarboxylic acid can be citric acid. The polycarboxylic acid, such as the citric acid, can be present in the polymer composition in an amount greater than about 0.001% by weight, such as in an amount greater than about 0.005% by weight, such as in an amount greater than about 0.01% by weight, such as in an amount greater than about 0.03% by weight. One or more polycarboxylic acids can be present in the polymer composition generally in an amount less than about 0.1% by weight, such as in an amount less than about 0.08% by weight, such as in amount less than about 0.06% by weight, such as in an amount less than about 0.04% by weight.

In addition to a cellulose ester polymer, one or more plasticizers, one or more antioxidants, and one or more polycarboxylic acids, the polymer composition can also contain various other additives and ingredients. For example, the polymer composition can also contain an odor masking agent. The odor masking agent, for instance, can absorb odors and/or produce its own odor. Masking agents that may be incorporated into the composition include zeolites, particularly synthetic zeolites, fragrances, and the like.

Other additives and ingredients that may be included in the polymer composition include pigments, lubricants, softening agents, antibacterial agents, antifungal agents, preservatives, flame retardants, and combinations thereof. Each of the above additives can generally be present in the polymer composition in an amount of about 5% or less, such as in an amount of about 2% or less, and generally in an amount of about 0.1% or greater, such as in an amount of about 0.3% or greater.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

It should be understood that many of the above additives and ingredients are optional. For instance, in particular embodiments, there may be advantages to excluding certain materials from the polymer composition. For example, in one aspect, the polymer composition is formulated without containing any filler particles, particularly white filler particles. Such particles, for instance, can adversely affect the optical properties of the molded article, especially during thermoforming.

The polymer composition can also be formulated without containing any tackifying resins. In still another aspect, the polymer composition can be free from any thermoplastic polymers except for the cellulose ester polymer. In one aspect, in addition to the cellulose ester polymer, the polymer composition contains other thermoplastic polymers in an amount less than about 5% by weight, such as in an amount less than about 2% by weight, such as in an amount less than about 1% by weight. In one particular aspect, the polymer composition only contains the cellulose ester polymer, one or more plasticizers, one or more antioxidants, and one or more polycarboxylic acids.

In order to produce thermoformed articles in accordance with the present disclosure, the components can be compounded together before forming a film. For instance, the polymer composition can be fed to an extruder and formed into pellets although this is optional.

Initially, the polymer composition is formed or extruded into a film and then fed through a vacuum or pressure thermoforming process. The film can be produced using any suitable method. In one aspect, for instance, the polymer composition is heated to a temperature and melt-extruded to form the film. For example, the composition can be heated to a viscosity of from about 50,000 cp to about 200,000 cp, such as from about 80,000 cp to about 120,000 cp.

Any suitable extruder can be used in order to produce the film. For example, the extruder can be a co-rotating twin screw extruder or alternatively can be a single screw extruder. During extrusion, the polymer composition can generally be heated to a temperature of from about 170° C. to about 235° C., such as from about 190° C. to about 220° C. In one aspect, the hot molten polymer is fed onto a polished metal band or drum with an extrusion die. Once on the band or drum, the film can be cooled and peeled from the metal support. The formed film can have a thickness of greater than about 0.3 mm, such as greater than about 0.5 mm, such as greater than about 0.8 mm, such as greater than about 1 mm, such as greater than about 1.5 mm, such as greater than about 2 mm, such as greater than about 2.5 mm, such as greater than about 3 mm. The thickness of the film is generally less than about 5 mm, such as less than about 3 mm, such as less than about 2 mm, such as less than about 1.5 mm.

If desired, the film may be uniaxially stretched or biaxially stretched using any suitable method. For instance, the film can be stretched using a roll method or using a tenter frame. Stretching the film can thin the film and possibly improve optical properties. The draw ratio in the machine direction or the cross-machine direction can generally be from about 1.5 to about 4, such as from about 2 to about 3.

In still another embodiment, the film can be formed through a solution cast method. In this method, the polymer composition can be combined with a solvent, such as acetone, which is then evaporated during formation of the film.

Once the film is formed, the film is then fed through a thermoforming process in order to form a three-dimensional article. The film, if desired, can be pretreated prior to thermoforming. For example, the film can be subjected to a heat treatment for removing stress and/or can be soaked in an aqueous solution if desired.

The temperature and pressure to which the film is subjected during the thermoforming process can vary depending upon various different factors including the thickness of the film and the type of product being formed. In general, thermoforming may be conducted at a temperature of from about 75° to about 120°, such as from about 75° to about 100°. Higher temperatures, however, can also be used. As described above, the film is also subjected to pressure and/or suction forces that press the film against a mold for conforming the film to the shape of the mold. Once molded, the three-dimensional article can be trimmed and/or polished as desired.

All different types of products and articles can be formed in accordance with the present disclosure. For instance, the thermoforming process can be used to produce automotive parts including door handles, cup holders, dashboards, and the like. In addition, consumer appliance components can also be formed through the process of the present disclosure, including handles and other parts. The process of the present disclosure can also be used to produce all different types of food and beverage containers including food and beverage container lids. Containers made according to the present disclosure, for instance, can have heat resistance and thus can be used to hold hot foods.

Other articles that may be made in accordance with the present disclosure include electrical and electronic device enclosures including computer monitor enclosures, laptop enclosures, cellular phone enclosures, and the like.

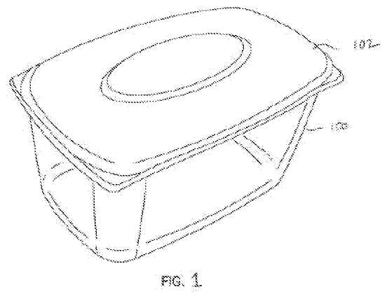

By way of example, FIG. 1 illustrates a food container 100 made in accordance with the present disclosure. The food container 100 includes a lid 102. In some instances, the food container 100 and the lid 102 can both be made from the polymer composition of the present disclosure.

All different types of articles and products can be made in accordance with the present disclosure. In one aspect, the three-dimensional article comprises food packaging or all other types of packaging. The packaging can be rigid, semi-rigid or flexible. The packaging can be used to hold all different types of food products, such as meat products, eggs, fresh fruit, produce, and the like. The packaging can also be used to hold and store various different medical components, such as tools, syringes, needles, tubing, and vials.

Thermoformed products made according to the present disclosure can be used in all different types of industries to produce a limitless variety of products. For example, various medical equipment can be made in accordance with the present disclosure including medical electronics housing, imaging enclosures, sterile packaging, bins, trays, hospital room panels, hospital bed components, stands and support equipment, and the like. Articles made according to the present disclosure can also be used to produce all different types of parts in the automotive industry. Such parts include dashboard assemblies, interior door panels, interior paneling, seat parts, engine bay paneling, exterior body panels, bumpers, air ducts, trunk liners, glove compartments, guards, spoilers, window louvres, and the like.

Articles made according to the present disclosure can also be used in the aviation field to produce aircraft interior paneling, galley components, overhead luggage bins, seat parts, window shades, light housings, ductwork parts, arm rests, foldable tray tables, and the like. Articles made according to the present disclosure can also be used to produce parts for business machines and equipment. For instance, products made according to the present disclosure include printer enclosures, fax machine enclosures, electronic enclosures, panels, bezels, office furniture parts, computer enclosures, and electronic packaging.

Articles made according to the present disclosure can also be used in the building and construction industry to produce all different types of products such as equipment enclosures, skylight parts, tool cases, machinery covers, and the like. Thermoformed products made according to the present disclosure can also be used to produce all different types of consumer appliance parts. For instance, the thermoforming process of the present disclosure can be used to produce refrigerator parts, refrigerator and freezer door liners, dishwasher parts, parts for clothes dryers, parts for window air conditioners, and parts for other various different consumer appliances, including television cabinets.

Articles made according to the present disclosure can also be used to produce all different types of recreation products. Recreation products that can be made according to the present disclosure include parts for exercise and fitness machines, equipment enclosures, external panels for recreational vehicles, protective cases in order to store all different types of athletic equipment, fishing boat hulls, canoe and boat parts, windshields for boats, snowmobiles and motorcycles, and the like. Thermoformed articles made according to the present disclosure are also well suited for use in the horticulture industry. Products that can be made include, for instance, plant trays, flowerpots, and the like.

The polymer composition of the present disclosure can also be used to thermoform various different containers. Such containers include bins, trays, bases. In addition, all different types of drinking containers or other food containers and beverage holders can be made according to the present disclosure. Such beverage containers can include cups or tops to cups.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A thermoformed article comprising:
a film comprising a biodegradable polymer, the biodegradable polymer comprising a cellulose ester polymer, the film further comprising a plasticizer, the plasticizer being present in the film in an amount of from about 5% by weight to about 48% by weight; and
wherein the film has been subjected to sufficient heat and pressure in order to form a three-dimensional article with a defined shape, wherein the film, when tested according to a gel analysis test, displays defects having a size of 300 microns or greater of less than about 5,000 defects/m².

2. A thermoformed article as defined in claim 1, wherein the film, when tested according to a gel analysis test, displays defects having a size of 200 microns or greater of less than about 25,000 defects/m², displays defects having a size of 100 microns or greater of less than about 70,000 defects/m², and displays a total defect area of less than about 9,000 mm².

3. A thermoformed article as defined in claim 1, wherein the film further comprises one other bio-based polymer in addition to the cellulose ester polymer.

4. A thermoformed article as defined in claim 1, wherein the film further comprises an antioxidant, the antioxidant comprising a phosphite.

5. A thermoformed article as defined in claim 4, wherein the phosphite comprises a diphosphite, the diphosphite being present in the three-dimensional article in an amount from about 0.001% by weight to about 0.35% by weight.

6. A thermoformed article as defined in claim 1, wherein the three-dimensional article further comprises a polycarboxylic acid.

7. A thermoformed article as defined in claim 6, wherein the polycarboxylic acid comprises citric acid, the citric acid being present in the three-dimensional article in an amount from about 0.001% by weight to about 0.1% by weight.

8. A thermoformed article as defined in claim 1, wherein the film comprises an extruded film.

9. A thermoformed article as defined in claim 1, wherein the film has been uniaxially or biaxially stretched.

10. A thermoformed article as defined in claim 1, wherein the cellulose ester polymer comprises a cellulose acetate, the cellulose acetate comprising primarily cellulose diacetate.

11. A thermoformed article as defined in claim 1, wherein the three-dimensional article contains the cellulose ester polymer in an amount from about 62% to about 74% by weight and contains the plasticizer in an amount from about 27% by weight to about 36% by weight.

12. A thermoformed article as defined in claim 1, wherein the cellulose ester polymer comprises a cellulose acetate having a degree of substitution of from about 2.1 to about 2.8.

13. A thermoformed article as defined in claim 1, wherein the three-dimensional article having a defined shape includes at least one wall, the at least one wall having a haze of less than about 10% when tested according to ASTM Test D1003 (2013).

14. A thermoformed article as defined in claim 1, wherein the three-dimensional article having a defined shape is transparent or translucent and has optical properties such that a user can view the contents of the three-dimensional article through the walls of the article.

15. A thermoformed article as defined in claim 1, wherein the three-dimensional article comprises food packaging.

16. A thermoformed article as defined in claim 1, wherein the plasticizer comprises a triglyceride.

17. A thermoformed article as defined in claim 1, wherein the plasticizer comprises tris(chloroisopropyl) phosphate, tris(2-chloro-1-methylethyl) phosphate, glycerin, triethyl citrate, acetyl triethyl citrate, an adipate, polyethylene glycol, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, an aromatic diol, a substituted aromatic diol, an aromatic ether, tripropionin, tribenzoin, a glycerin ester, glycerol tribenzoate, glycerol acetate benzoate, polyethylene glycol, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrrolidinone, propylene carbonate, a C1-C20 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, a monoacetyglycol, a diacetylglycol, a piperidine, a piperazine, hexamethylene diamine, triazine, triazole, a pyrrole, and mixtures thereof.

18. A thermoformed article as defined in claim 1, wherein the plasticizer comprises 1,2,3-triacetylglycol.

19. A thermoformed article as defined in claim 1, wherein the cellulose ester polymer comprises cellulose acetate and is present in the three-dimensional article in an amount from about 62% by weight to about 74% by weight, the plasticizer being present in the three-dimensional article in an amount from about 27% by weight to about 36% by weight, the plasticizer comprising a triglyceride, the three-dimensional article further containing citric acid in an amount from about 0.001% by weight to about 0.1% by weight and a diphosphite antioxidant in an amount from about 0.001% by weight to about 0.35% by weight, the cellulose acetate having a degree of substitution of from about 2.1 to about 2.8.

20. A polymer composition for forming molded articles comprising:
a cellulose ester polymer present in the polymer composition in an amount from about 62% by weight to about 74% by weight, the cellulose ester polymer comprising a cellulose acetate, the cellulose acetate comprising primarily cellulose diacetate;
a plasticizer blended with the cellulose ester polymer, the plasticizer comprising a triglyceride and being present in the polymer composition in an amount from about 27% by weight to about 36% by weight;
an antioxidant comprising a phosphite; and
a polycarboxylic acid.

21. A polymer composition as defined in claim 20, wherein the polymer composition, when tested according to ASTM Test D1003 (2013) displays a haze at 1 mm of less than about 5%.
